(19) United States
(12) Patent Application Publication
(10) Pub. No.: US 2005/0231154 A1
(43) Pub. Date: Oct. 20, 2005

(54) Portable information device with an auxiliary power circuit

(76) Inventor: Wen-Hsiang Yueh, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/101,508

(22) Filed: Apr. 8, 2005

(30) Foreign Application Priority Data
Apr. 20, 2004 (TW) 93206093

(51) Int. Cl. H02J 7/00

(52) U.S. Cl. 320/103

(57) ABSTRACT

A portable information device with an auxiliary power circuit makes use of a solar electric power generator and various kinds of manual electric generators to produce redundant power. The portable information device with an auxiliary power circuit has a load circuit, a backup battery connected to the load circuit to provide a redundant power source for the load circuit, a power-generating unit for supplying electric power, a power control unit connected to the power-generating unit to receive the supplied electric power and then control, process, and selectively output the supplied electric power, and a charging circuit connected to the power control unit and the backup battery and used to charge the backup battery based on the supplied electric power.

### BACKGROUND OF THE INVENTION

1. Field of the Invention

The present invention relates to a portable information device with an auxiliary power circuit and, more particularly, to a portable information device capable of making use of a solar electric power generator and various kinds of manual electric generators to perform power-generating actions and also storing electricity in a rechargeable backup battery to provide a redundant power source.

2. Description of Related Art

In this digital era, various digital products are commercially available. Portable information devices emphasizing compact size and convenient portability, such as personal digital assistants (PDAs), digital cameras, portable MP3 players, and mobile phones, are widespread. Their common feature is that a battery is used to provide electric power required by a load circuit therein. The battery, however, often runs out of power, or becomes low in power, during use of a portable information device. If a user does not bring a backup battery for replacement, the portable information device cannot be used normally.

### SUMMARY OF THE INVENTION

Accordingly, an object of the present invention is to provide a portable information device with an auxiliary power circuit. The portable information device makes use of a solar electric power generator and a manual electric generator to supply electric power. The supplied electric power is sent to a charging circuit via a power control unit. The charging circuit is used to charge a backup battery. The backup battery provides a redundant power source for a load circuit in the portable information device.

To achieve the above object, the present invention provides a portable information device with an auxiliary power circuit. A power control unit is connected to a power-generating unit. The power control unit receives electric power supplied by the power-generating unit, and then controls, processes, and selectively outputs the supplied electric power to a charging circuit. The charging circuit charges a backup battery based on the supplied electric power. The backup battery is connected to a load circuit in the portable information device, and is used to provide a redundant power source for the load circuit.

The above power-generating unit comprises a solar electric power generator, a manual electric generator, or both. The solar electric power generator is connected to at least a solar energy collecting board via a solar-to-electric energy conversion unit. These solar energy collecting boards are disposed on the portable information device, and are used to absorb the energy from solar light or other light sources. The solar-to-electric energy conversion unit then converts the energy to electric power.

The above manual electric generator is a rotary electric generator or a reciprocating electric generator. The rotary electric generator has a gear train mechanically coupled with a primary spring and a magnetized rotor. The gear train is driven by a tensile force of the primary spring to lead the magnetized rotor to rotate. At least a coil is used to produce electric power through induction. The reciprocating electric generator has an N-S magnet disposed between a coil winding. The N-S magnet reciprocates between the coil winding to produce electric power through induction.

### BRIEF DESCRIPTION OF THE DRAWINGS

The various objects and advantages of the present invention will be more readily understood from the following detailed description when read in conjunction with the appended drawing, in which:

FIG. 1 is a circuit block diagram of the present invention;

FIG. 2 is a circuit block diagram of a power control unit used in the present invention;

FIG. 3 is a circuit block diagram of a solar electric power generator used in the present invention;

FIG. 4 is a circuit block diagram of a rotary electric generator used in the present invention; and

FIG. 5 is a circuit block diagram of a reciprocating electric generator used in the present invention.

### DETAILED DESCRIPTION OF THE PREFERRED EMBODIMENTS

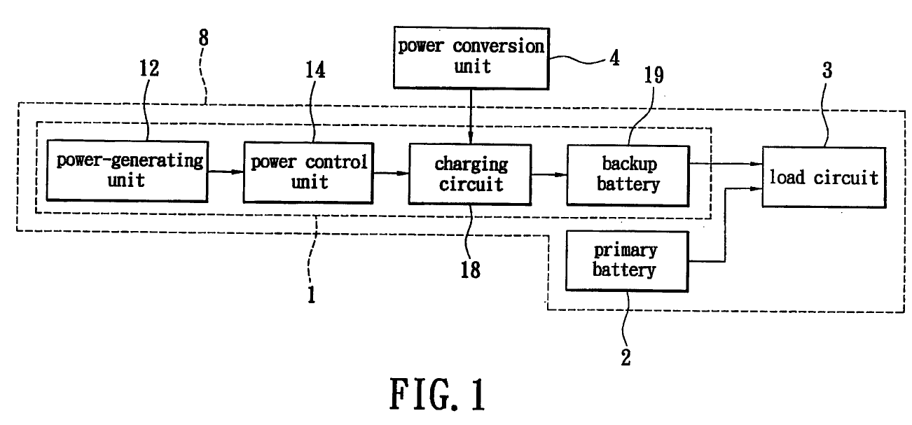

As shown in FIG. 1, a portable information device 8 of the present invention at least comprises a power-generating unit 12, a power control unit 14, a charging circuit 18, a backup battery 19, and a load circuit 3.

The power-generating unit 12 is connected to the power control unit 14 and is used to produce electric power sent to the power control unit 14. The power control unit 14 is connected to the charging circuit 18, and is used to receive the supplied electric power and then control, process, and selectively output the supplied electric power to the charging circuit 18. The charging circuit 18 is connected to the backup battery 19 and used to charge the backup battery 19 based on the supplied electric power. The backup battery 19 is connected to the load circuit 3 in the portable information device 8 and used to provide a redundant power source for the load circuit 3. The above power-generating unit 12 is a solar electric power generator, a manual electric generator, or both.

The portable information device 8 further comprises a primary battery 2. The primary battery 2 is connected to the load circuit 3 and used to provide electric power required by the load circuit 3. A power conversion unit 4 is connected to the charging circuit 18 in the portable information device 8 and used to convert an AC power to a DC power and also provide electric power for the charging circuit 18 to charge the backup battery 19.

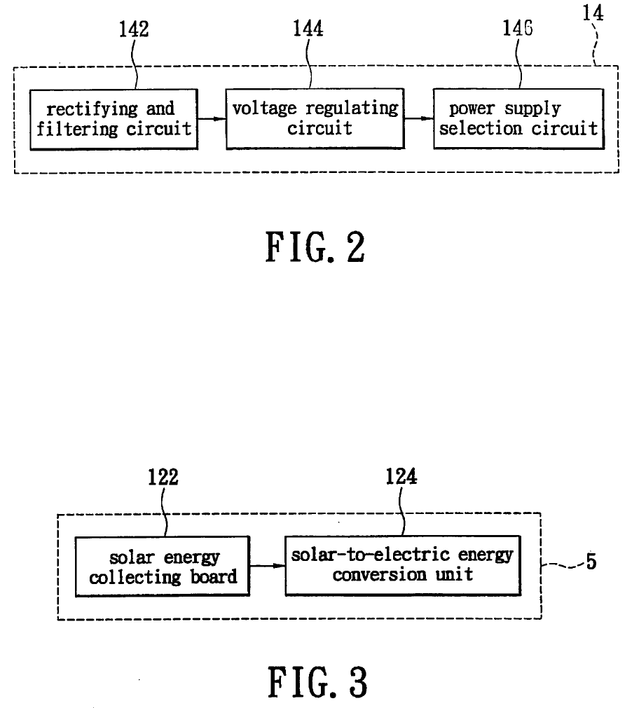

Reference is made to FIG. 2 as well as FIG. 1. The power control unit 14 comprises a rectifying and filtering circuit 142, a voltage regulating circuit 44, and a power supply selection circuit 146. The power control unit 14 is connected to the power-generating unit 12 via the rectifying and filtering circuit 142. The power control unit 14 is used to receive, and then rectify and filter, the supplied electric power. The voltage regulating circuit 44 is connected to the rectifying and filtering circuit 142 and is used to regulate the supplied rectified and filtered electric power. The power supply selection circuit 146 is connected to the voltage regulating circuit 144 and the charging circuit 18. The power supply selection circuit 146 is used to receive the supplied rectified, filtered, and regulated electric power and then control, process, and selectively output the supplied electric power to the charging circuit 18. The supplied electric power can be from a solar electric power generator or a manual electric generator.

Reference is made to FIG. 3 as well as FIG. 1. A solar electric power generator 5 has at least a solar energy collecting board 122 disposed on the portable information device 8 and is used to absorb energy from solar light or other light sources. A solar-to-electric energy conversion unit 124 is connected to these solar energy collecting boards 122 and the power control unit 14, and is used to convert the energy supplied by these solar energy collecting boards 122 to electric power sent to the power control unit 14.

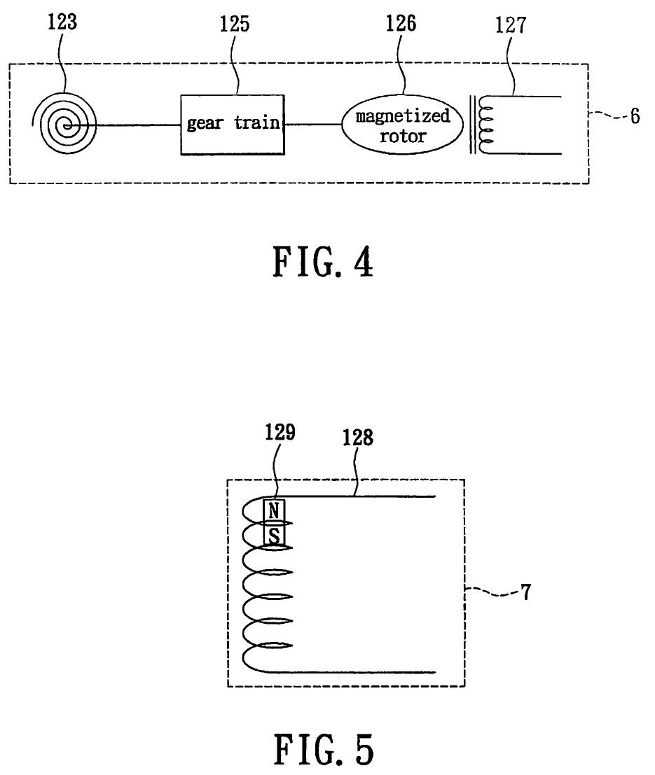

Reference is made to FIG. 4 as well as FIG. 1. A rotary electric generator 6 comprises a primary spring 123, a gear train 125, a magnetized rotor 126, and at least a coil 127. The gear train 125 is mechanically coupled with the primary spring 123 and the magnetized rotor 126. The gear train 125 is driven by a tensile force of the primary spring 123 to lead the magnetized rotor 126 to rotate. These coils 127 are used to produce through induction electric power sent to the power control unit 14 when the magnetized rotor 126 rotates.

Reference is made to FIG. 5 as well as FIG. 1. A reciprocating electric generator 7 has an N-S magnet 129 arranged between a coil winding 128. The N-S magnet 129 reciprocates between the coil winding 128 to produce through induction electric power sent to the power control unit 14.

Reference is again made to FIG. 1. An auxiliary power circuit 1 of a portable information device 8 comprises a power-generating unit 12, a power control unit 14, a charging circuit 18, and a backup battery 19. The auxiliary power circuit 1 is disposed in the portable information device 8 and is used to provide a redundant power source for a load circuit 3 in the portable information device 8. The circuit actions and principles of the auxiliary power circuit 1 are the same as those describe above and therefore are not described further herein.

To sum up, the portable information device with an auxiliary power circuit of the present invention makes use of the solar electric power generator 5 and the manual electric generator (not shown) to produce electric power. The power control unit 14 controls, processes, and selectively outputs the supplied electric power to the charging circuit 18. The charging circuit 18 charges the backup battery 19 based on the supplied electric power. The backup battery 19 provides a redundant power source for the load circuit 3 in the portable information device 8. When the battery of a portable information device 8, such as a PDA, a digital camera, a portable MP3 player, or a mobile phone, runs out of power or has low power, the solar electric power generator 5 or the manual electric generator (not shown) of the portable information device 8 can be used to provide electric power for the load circuit 3 in the portable information device 8, thereby maintaining normal operation of the portable information device 8.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

1. A portable information device with an auxiliary power circuit, comprising:
a load circuit;
a backup battery connected to said load circuit and used to provide a redundant power source for said load circuit;
a power-generating unit for supplying electric power;
a power control unit connected to said power-generating unit, wherein said power control unit is used to receive said supplied electric power, and said power control unit then controls, processes, and selectively outputs said supplied electric power; and
a charging circuit connected to said power control unit and said backup battery and used to charge said backup battery based on said supplied electric power.

2. The portable information device with an auxiliary power circuit as claimed in claim 1, wherein said charging circuit is further connected to a power conversion unit, said power conversion unit is used to convert AC power to DC power, and said power conversion unit also provides electric power for said charging circuit to charge said backup battery.

3. The portable information device with an auxiliary power circuit as claimed in claim 1, wherein said power-generating unit is a solar electric power generator.

4. The portable information device with an auxiliary power circuit as claimed in claim 1, wherein said power-generating unit is a manual electric generator.

5. The portable information device with an auxiliary power circuit as claimed in claim 1, wherein said power-generating unit is composed of a solar electric power generator and a manual electric generator.

6. The portable information device with an auxiliary power circuit as claimed in claim 3, wherein said solar electric power generator comprises:
at least a solar energy collecting board disposed on said portable information device and used to absorb energy from solar light or other light sources; and
a solar-to-electric energy conversion unit connected to said solar energy collecting boards and said power control unit, wherein said solar-to-electric energy conversion unit converts energy supplied by said solar energy collecting boards into electric energy.

7. The portable information device with an auxiliary power circuit as claimed in claim 4, wherein said manual electric generator is a rotary electric generator.

8. The portable information device with an auxiliary power circuit as claimed in claim 7, wherein said rotary electric generator comprises:
a primary spring wound by a manual or automatic winding mechanism;
a gear train mechanically coupled with said primary spring and a magnetized rotor, said gear train being driven by a tensile force of said primary spring to rotate said magnetized rotor; and
at least a coil used to produce electric power through induction when said magnetized rotor rotates.

9. The portable information device with an auxiliary power circuit as claimed in claim 4, wherein said manual electric generator is a reciprocating electric generator.

10. The portable information device with an auxiliary power circuit as claimed in claim 9, wherein said reciprocating electric generator has an N-S magnet arranged between a coil winding, and said N-S magnet reciprocates between said coil winding to produce electric power through induction.

11. The portable information device with an auxiliary power circuit as claimed in claim 1, wherein said power control unit comprises:
a rectifying and filtering circuit connected to said power-generating unit, wherein said rectifying and filtering circuit receives said supplied electric power, and then rectifies and filters said supplied electric power;
a voltage regulating circuit connected to said rectifying and filtering circuit, wherein said voltage regulating circuit performs voltage regulation on said supplied electric power after rectifying and filtering; and
a power supply selection circuit connected to said voltage regulating circuit and said charging circuit, wherein said power supply selection circuit controls, processes, and selectively outputs said supplied electric power, having been rectified, filtered and regulated, to said charging circuit.

12. The portable information device with an auxiliary power circuit as claimed in claim 1, further comprising a primary battery, wherein said primary battery is connected to said load circuit to provide electric power required by said load circuit.

13. An auxiliary power circuit disposed in a portable information device and used to provide a redundant power source for a load circuit in said portable information device, said auxiliary power circuit comprising:
a backup battery connected to said load circuit and used to provide said redundant power for said load circuit;
a power-generating unit for supplying electric power;
a power control unit connected to said power-generating unit, wherein said power control unit receives said supplied electric power, and then controls, processes, and selectively outputs said supplied electric power; and
a charging circuit connected to said power control unit and said backup battery, wherein said charging circuit charges said backup battery based on said supplied electric power.

14. The portable information device with an auxiliary power circuit as claimed in claim 13, wherein said power-generating unit is a solar electric power generator.

15. The portable information device with an auxiliary power circuit as claimed in claim 13, wherein said power-generating unit is a manual electric generator.

16. The portable information device with an auxiliary power circuit as claimed in claim 13, wherein said power-generating unit is composed of a solar electric power generator and a manual electric generator.

17. The portable information device with an auxiliary power circuit as claimed in claim 14, wherein said solar electric power generator comprises:
at least a solar energy collecting board disposed on said portable information device and used to absorb energy from solar light or other light sources; and
a solar-to-electric energy conversion unit connected to said solar energy collecting boards and said power control unit, wherein said solar-to-electric energy conversion unit converts energy supplied by said solar energy collecting boards into electric energy.

18. The portable information device with an auxiliary power circuit as claimed in claim 15, wherein said manual electric generator is a rotary electric generator.

19. The portable information device with an auxiliary power circuit as claimed in claim 18, wherein said rotary electric generator comprises:
a primary spring wound by a manual or automatic winding mechanism;
a gear train mechanically coupled with said primary spring and a magnetized rotor, said gear train being driven by a tensile force of said primary spring to rotate said magnetized rotor; and
at least a coil used to produce electric power through induction when said magnetized rotor rotates.

20. The portable information device with an auxiliary power circuit as claimed in claim 15, wherein said manual electric generator is a reciprocating electric generator.

21. The portable information device with an auxiliary power circuit as claimed in claim 20, wherein said reciprocating electric generator has an N-S magnet arranged between a coil winding, and said N-S magnet reciprocates between said coil winding to produce electric power through induction.

22. The portable information device with an auxiliary power circuit as claimed in claim 13, wherein said power control unit comprises:
a rectifying and filtering circuit connected to said power-generating unit, wherein said rectifying and filtering circuit receives said supplied electric power, and then rectifies and filters said supplied electric power;
a voltage regulating circuit connected to said rectifying and filtering circuit, wherein said voltage regulating circuit performs a voltage regulation action on said supplied electric power, having been rectified and filtered; and
a power supply selection circuit connected to said voltage regulating circuit and said charging circuit, wherein said power supply selection circuit controls, processes, and selectively outputs said supplied electric power, having been rectified, filtered, and regulated, to said charging circuit.

23. The portable information device with an auxiliary power circuit as claimed in claim 13, further comprising a primary battery, wherein said primary battery is connected to said load circuit to provide electric power required by said load circuit.
